(19) United States
(12) Patent Application Publication
(10) Pub. No.: US 2017/0113335 A1
(43) Pub. Date: Apr. 27, 2017

(54) HANDTOOL WITH LED LIGHT

(71) Applicant: ALTIN TAULLAJ, FONTANA, CA (US)

(72) Inventor: ALTIN TAULLAJ, FONTANA, CA (US)

(21) Appl. No.: 14/922,191

(22) Filed: Oct. 25, 2015

(51) Int. Cl. B25B 23/18; F21L 4/02; B25B 15/02; F21V 23/04; F21V 23/00; F21V 21/40; F21V 33/00

(52) U.S. Cl. CPC B25B 23/18; F21V 21/406; F21L 4/02; F21V 33/0084; F21V 23/0421; F21V 23/001; B25B 15/02

(57) ABSTRACT

An illuminated tool includes a solid core handle, a power source encapsulated within the solid core handle, a LED light source attached to and situated at the first end of the solid core handle and proximate to a metal shaft attached to and extending from the first end of the handle. Wires situated in a bore within the solid core handle extend through the bore from the LED light source to the power source. A cover is removably fastened to the second end of the solid core handle to serve as access and cover for the power source and also contains a switch which serves to complete the circuit from power source to LED light source.

### FIELD OF INVENTION

The present invention relates to hand tools structured and disposed to deliver light from the tool's handle toward the end of the shaft of the tool.

### DESCRIPTION OF THE PRIOR ART

Tools for driving fasteners are common. Conventional screwdrivers include a solid handle that is usually made of wood, rubber or plastic and from which a rigid metal shaft extends. The end of the shaft is variously shaped to engage a variety of correspondingly shaped screw heads. Lighted Screwdrivers are also common and have been fashioned with a light source positioned in the handle to direct light toward the screw-engaging end of the shaft to permit the user to fasten screws in poorly lit areas. Examples in the art include U.S. Pat. Nos.: Nalbandian U.S. Pat. No. 4,283,757; McKain, U.S. Pat. No. 5,369,555; Singelton, U.S. Pat. No. 4,107,765; and Berg U.S. Pat. No. 4,936,171.

The prior art generally discloses a battery powered lighted hand tool with variations on placement of the at least one light source and a power source typically situated within a recess in the handle. The shortcomings attributed to the prior art are that the type and/or placement of the light source used are insufficient to properly illuminate the work area and render the light source prone to damage or breakage. Also, the placement of the power source and its attendant circuitry renders the handle structurally deficient, thereby compromising the integrity, usefulness and working lifespan of the screwdriver. Another shortcoming of the prior art is that the type of light source, power source and attendant circuitry are such that they cannot effectively be used with small handled screwdrivers. Such screwdrivers are becoming more prevalent as required use with, for example, portable electronic devices.

What is needed therefore is a lighted tool that can provide a strong source of concentrated light connected to a sufficient power source situated within the handle in a manner that does not compromise the strength, integrity and usefulness of the handle. What is also needed is a lighted tool that can provide a strong source of light with sufficient power that can be packaged within a very small handled tool.

### SUMMARY OF THE INVENTION

A tool is provided with a solid core handle and a metal shaft attached to and extending away from the lower portion of the handle. The handle comprises at least two recesses, one in the upper portion of the handle and at least one in the lower portion of the handle. The upper portion recess houses a power source and is covered by a threadably secured cap which contains a switch and circuitry and which cap is designed, when secured, to form the end of the upper portion of the handle and to engage the power source and complete the light circuit. The lower portion recess contains an LED light secured in the end of the lower portion of the handle near the metal shaft and disposed to direct light away from the handle toward the distal end of the metal shaft. The two recesses are connected by two internal bores in the handle through which wire circuitry is situated connecting the LED light source to the battery and switch.

The primary object of the present invention is to provide a tool having a light emitting device, whereby the tool provides sufficient light to clearly illuminate the working area while housing the power source and light in the handle of the tool without sacrificing the strength and effectiveness of the handle. Another object of the present invention is to provide a tool with a light emitting device whereby the light and power source for the light are positioned in the handle of the tool in a manner allowing for the manufacture of a tool that is compact enough for use in small spaces and that is appropriate size for fine, detailed use.

### BRIEF DESCRIPTION OF THE DRAWINGS

FIG. 1 is a perspective view of a preferred embodiment of the invention

FIG. 2 is partial cutaway view showing the internal structure of the handle of the tool.

FIG. 3 is a front view of a preferred embodiment of the invention showing the structures associated with the front end of the tool.

FIG. 4 is a sectional side view of the preferred embodiment of the invention showing the structure associated with the lower portion and first end of the tool.

FIG. 5 is a cut away view of the preferred embodiment of the invention showing the cap structure and power source placement within the handle.

FIG. 6 is a partial side view of the invention showing details regarding the metal shaft and preferred embodiments of the distal end of the shaft.

FIG. 7 is an exploded view of the switch means and the associated structures of the invention

### DETAILED DESCRIPTION

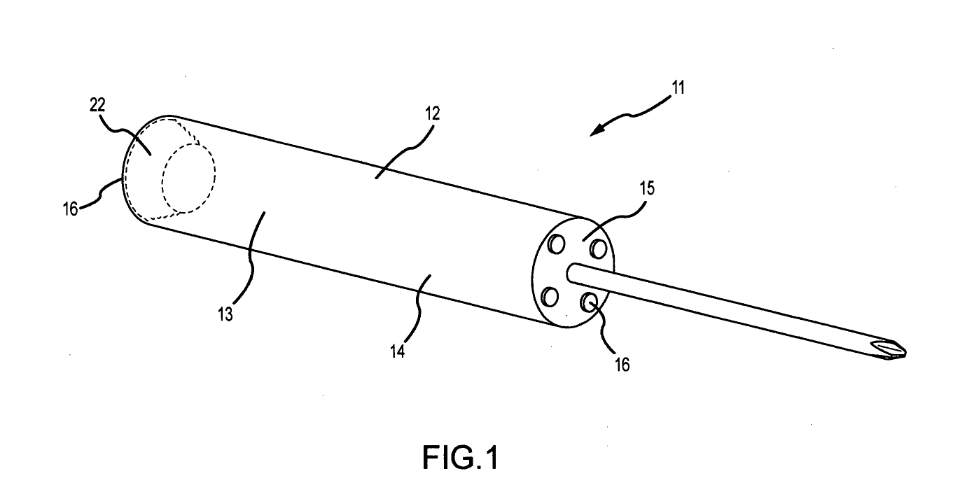

An illuminated tool incorporating the mechanisms of the invention is shown in FIG. 1. The screwdriver of the present invention includes a solid core handle 12. The handle 12 includes an upper portion 13 and a lower portion 14. The handle 12 is generally cylindrical in shape and includes a first end 15 and an opposite second end 16. The handle is made of plastic or wood and is of proper length to permit sufficient space between the upper portion and lower portion to maintain structural integrity.

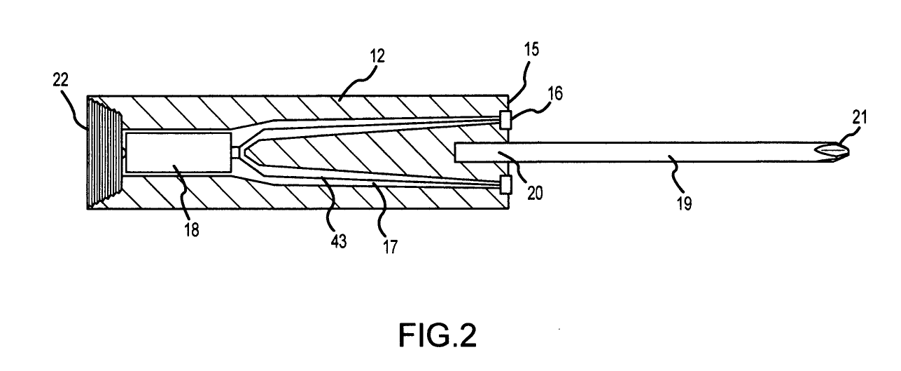

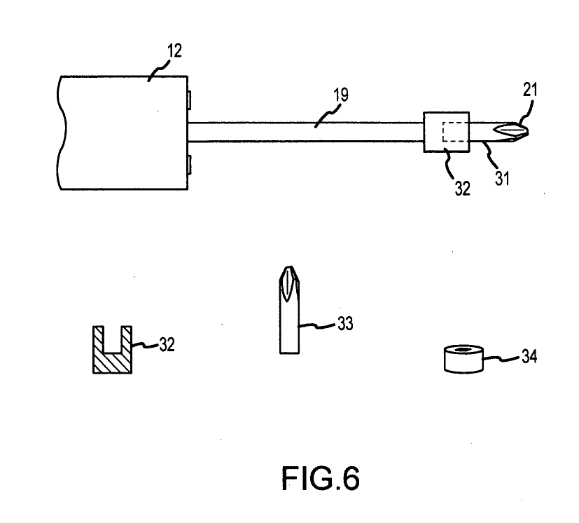

As shown in FIG. 2, a metal shaft 19 has a proximal end portion 20 that is embedded in the lower portion of the handle 12 extending out from the first end 15 of the lower portion 14 and ending at a free distal end 21. The shaft 19 is supported by the lower portion of the handle 14 and remains fixedly attached to the handle 12. The distal end 21 of the shaft 19 may be configured to define a screwdriver tip of any commercially available type. As shown in FIG. 6, the shaft 19 may also be configured to terminate with a socket 32 to allow the fitment of any various types of tool elements 31 to allow the tip to engage with a variety of fastener devices. In other embodiments, the distal end 21 of the shaft 19 may be configured to define any shape and type of fastener.

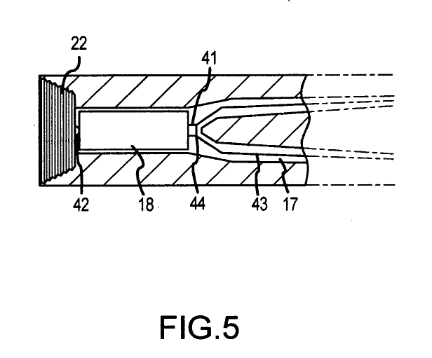

Referring again to FIG. 2, a power source 18 is encapsulated within a shallow recess in the upper portion of the handle. In a preferred embodiment of the invention, the recess is shaped to accept AAA sized batteries currently commercially available. An illustration of this embodiment of the present invention is further illustrated in FIG. 2, wherein the power source is generally located along the axial center-line of the handle 12 and extends from the second end 16 in the upper portion 13 to a point within the upper portion 13 of the handle 12 and does not extend to the lower portion 14 of the handle 12. Referring to a preferred embodiment shown in FIG. 5, the battery power source 17, has a central positive terminal 41 at one end of the battery 17 and a negative terminal 42 at the other end of the battery 17. A metal contact strip 44 provides a point of contact between the positive terminal 41 and the LED light source, which is in electrical contact with the battery through a wire 43 placed through a bore 17 in the handle 12.

The bore 17 within the interior of the handle is such that its placement does not significantly weaken the material of the handle and with a diameter sufficient only to house the wire but thus maintaining the structural integrity of the handle 12 and allowing the user to place pressure on the handle 12, consistent with its intended purpose, without danger of breaking or otherwise damaging the handtool. In addition, the length of the bore 17 is sufficient to travel from the upper portion 13 of the handle 12 through the lower portion 14 of the handle 12 to the LED light 16 embedded in the first end 15 of the lower portion 14 of the handle 12.

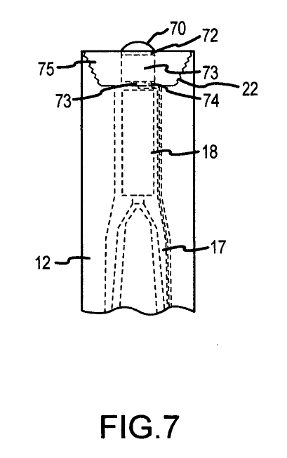

As shown in FIG. 7, The electrical circuit is closed by means of a switch means 75, which is a screw member rotatably attached to the handle 12 to form the end cap 22 at the second end 16 of the handle 12. The switch means contains a pushbutton 70 that is mounted externally and forms the second end 16 of the handle 12. A circuit board 72 is situated internally and forms a base for the pushbutton 70. A conductive surface 73 is situated within the switch means 75. The circuit board 72 is connected to the LED Light 15 via wire placed within the bore 17 that runs from the input of the circuit board 74 to the LED light 15. The circuit board is also connected to the power source 18 by means of a conducting surface 73. The battery 18 is in electrical contact with the LED light source 16 by means of a second wire 43 situated within the bore 17 running from the positive terminal of the battery 41 to the LED light 16. Rotation of the switch means advances the conducting surface 73 toward the negative terminal of the battery 18.

FIG. 5 provides an overview of the electrical connections between the power source 18 and the LED light 16. Specifically, as seen in FIG. 5, the end cap 22 containing the switch means 75 illustrated in detail in FIG. 7, is in electrical contact with the negative end 42 of the battery 18 and the positive terminal 41 of the battery in contact with a metal contact strip 44 to which a wire 43 is attached and which wire 43 travels through a bore 17 to connect with a LED light 16 embedded in the first end 15 of the handle 12.

As seen in FIGS. 4, in one preferred embodiment, a LED light 16 is encapsulated within a recess of the lower portion 14 of the handle 12 and is positioned so that it sits flush with the first end 15 of the handle 12 to provide structural integrity to the handle 12, provide for ease of cleaning and to protect the LED light 16 from damage. The LED 16 is disposed to direct light outwardly from the first end 15. Upon activation of the LED light 16 by depressing the pushbutton 70, light is directed to the distal end 21 of the metal shaft 19.

As shown by FIG. 2, the arrangement and structure of the hand tool components in this fashion, namely the use of LED light 15, a bore 17 of small diameter sufficient only to carry the wire 43 and the placement of the bore 17 within and through an upper portion 13 and lower portion 14 of the handle, in addition to allowing for a handtool construction that maintains a proper and meaningful structural integrity, also allows for the construction of a handtool with a small diameter handle 12, thus providing a small handtool or screwdriver with powerful LED light 16 in a small enough package to be used with small electronic devices or for use in tight spaces where an otherwise larger-handled screwdriver would not be desirable.

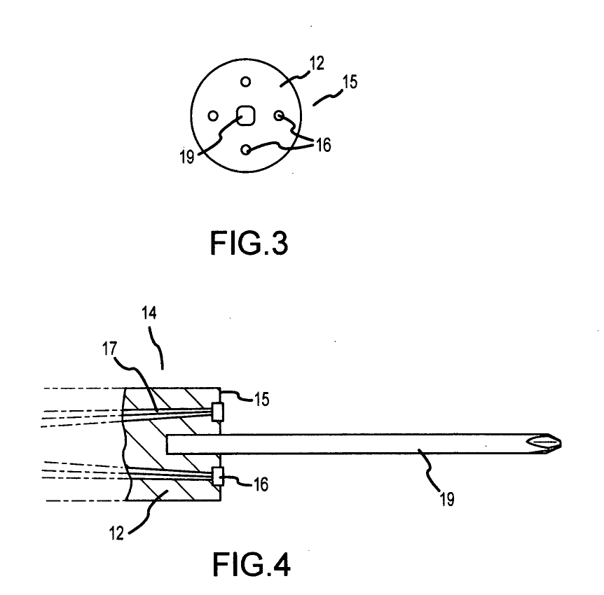

FIG. 3 provides another view of a preferred embodiment of the invention wherein a plurality of LED lights 16 are embedded in the first end 15 of the handle 12. The LED lights are positioned in a radial fashion around the metal shaft 19 to direct and concentrate light toward the distal end of the metal shaft 19.

FIG. 6 illustrates another embodiment of the present invention. As illustrated in FIG. 6 the distal end of the shaft 21 is designed to accept a removable socket 32 to further accept a plurality of removable and interchangeable heads 31, 33, and 33.

There has thus been described and provided a unique mechanism for closing an electrical circuit in an illuminated screwdriver whereby the mechanism does not interfere or otherwise compromise the integrity and usefulness of the screwdriver handle. While a limited number of preferred embodiments have been disclosed it is expected and assumed that there are additional and varied embodiments available that practice the claimed invention.

1. A hand tool having a light emitting device comprising:
a handle having a lower portion and an upper portion, with at least one recess in a front end of said lower portion and one recess in said upper portion,
a power source situated within said recess in said upper portion,
at least one LED light source situated in said recess of said front end of said lower portion and flush with said front end of said handle,
a rigid shaft with an engaging end extending from said front end of said lower portion,
at least two bores within the interior of said handle with each bore extending from said recess in the said lower portion and extending to the said recess in said upper portion,
a switch means rotatably mounted on the back end of said upper portion and actuable by the depression of a pushbutton accessible from the exterior of the said back end of said upper portion of said handle, for providing an electrical connection between said LED light source and said power source,
said switch means comprising a circuit board situated in said back end of said upper portion, at least one input connected to said power source and at least one input connected to said LED light source by a wire placed within at least one of said bores.

2. The device according to claim 1 wherein each LED light source is mounted off the longitudinal centerline of said handle and spaced at equal angles from the each other LED light source.

3. The device according to claim 1 wherein the length of said upper portion is three times the length of said lower portion.

4. The device according to claim 1 wherein the distance between the upper recess and lower recess is at least 10cm.

5. The device according to claim 1 wherein the length of each bore is at least 8 cm.

6. The device according to claim 1 wherein the recess in said upper portion has a minimum depth of 2 cm.

7. The device of claim 1 wherein the handle is plastic.

8. The device of claim 1 wherein the tool is a screwdriver.

9. The device according to claim 1 wherein the power source is at least one battery.

10. The device of claim 1 wherein the rigid shaft comprises a removable head at its distal end for attachment of a plurality of tool members.
